(19) United States
(12) Patent Application Publication
(10) Pub. No.: US 2012/0089931 A1
(43) Pub. Date: Apr. 12, 2012

(54) LIGHTWEIGHT OPERATION AUTOMATION BASED ON GUI

(76) Inventor: SEBASTIAN STEINHAUER, Palo Alto, CA (US)

(21) Appl. No.: 12/898,735

(22) Filed: Oct. 6, 2010

(51) Int. Cl. G06F 3/048

(52) U.S. Cl. 715/764

(57) ABSTRACT

Systems and methods for operation automation based on GUI are described. A GUI session is generated in a server runtime environment. The GUI session includes a number of objects corresponding to GUI elements, as defined in a software application. The objects of the GUI session are simultaneously exposed to a number of GUI channels via a number of interfaces. Each of the GUI channels is compliant with a different access protocol. Client operation requests compliant with different protocols are executed in parallel against the objects of the GUI session via GUI channels with matching protocol compliancy.

### BACKGROUND

The development of the information technology (IT) industry can be characterized by growing complexity and sophistication of computer systems. Typically, end users of many modern software applications do not understand the structure or the interdependencies between the logical program units, e.g., the domain models. At the same time, experienced users of the complex software applications are familiar with the operations and the transactions they perform. By contrast, the developers of a software application clearly understand the underlying object structure, but often lack the specific knowledge and experience about the order and techniques for executing business transactions within the application graphical user interface (GUI).

Often, the introduction of new functionality in a complex software application causes disorientation and frustration among the end users. The reason is that the new functionality usually changes the working pattern of the users, regardless whether it is a completely new feature or a customization of an existing feature. For example, the GUI screens of the software application may be rearranged, new GUI elements may be included, the order of the performed operations may be altered, etc. This is a negative effect that is frequently observed, despite how logical, efficient and consistent the changes to an application are from the perspective of the underlying domain structure, e.g. the existing business objects and interdependencies between them.

Discrepancies in the knowledge possessed by experienced users versus software developers of the software applications leads to even more disadvantages. In many cases, the experienced users of a software application come up with ideas how to make the execution of various operations more efficient and productive in their specific working environment. However, the typical lifecycle of complex software applications excludes the introduction of new functionality in a dynamic fashion. Even simple changes to the software application may turn into costly and complex consulting engagements. Moreover, change proposals must be addressed within a predefined timeframe. Thus, the software developers cannot dynamically implement the ideas as generated by the experienced users.

### SUMMARY

Various embodiments of systems and methods for operation automation based on GUI are described herein. A GUI session is generated in a runtime environment established in a server computer system based on a software application currently executing in the runtime environment. The GUI session includes a number of objects corresponding to GUI elements, as defined in the software application. In one aspect, the objects of the GUI session are exposed in the runtime environment through a number of interfaces. In another aspect, each of the interfaces provides simultaneous access to the objects via a corresponding GUI channel. Each of the GUI channels is compliant with a different access protocol. A number of client operation requests directed to the objects of the GUI session and compliant with one or more access protocols are received at the server computer system. In yet another aspect, operation requests compliant with different protocols are executed in parallel against the GUI session via protocol corresponding GUI channels.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram of a system enabling operation automation based on GUI objects, according to one embodiment.

FIG. 2 illustrates a process for developing and executing GUI based client side programs, according to one embodiment.

FIG. 3 is a block diagram illustrating correspondence between an exemplary GUI screen elements and programming code snippets, according to one embodiment.

FIG. 4 illustrates a process for executing GUI based client operation requests at a server computer system, according to one embodiment.

FIG. 5 illustrates a process for executing GUI based client operation requests at a server computer system, according to one embodiment.

FIG. 6 is a block diagram of an exemplary computer system enabling operation automation based on GUI objects, according to one embodiment, according to one embodiment of the invention.

### DETAILED DESCRIPTION

Embodiments of techniques for lightweight operation automation based on GUI are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

Typically, some or most of the entities that are meaningful in a software application are defined as objects, e.g., business objects. The business objects are specified by both data and behavior characteristics. There is no rule what entity should be defined as a business object. For example, in an enterprise resource planning (ERP) software system, business objects may represent entities as large as corporations, and as small as a single line of an order form. The network of the specified business objects and the interrelationships between the business objects is known as a domain model. Usually, a number of software applications share the same domain model based on an enterprise context.

The GUI of a computer application typically specifies a hierarchy of objects, e.g. screen or GUI objects. For example, a GUI includes a window object with its pertinent properties, data elements and behavior. Further, the window object may be composed of different component objects like menu bars, buttons, labels, etc. For a software application, it is essential that the GUI object structure is coherent with the underlying domain model. Thus, the GUI objects of a software application are based on the underlying business objects. Often, the users of a software application do not have detailed knowledge about the domain model of the software application. However, experienced users are familiar with the GUI objects of the application. The functionality of a software application may be enhanced based on this GUI related knowledge, using the GUI objects to interact with the underlying business objects.

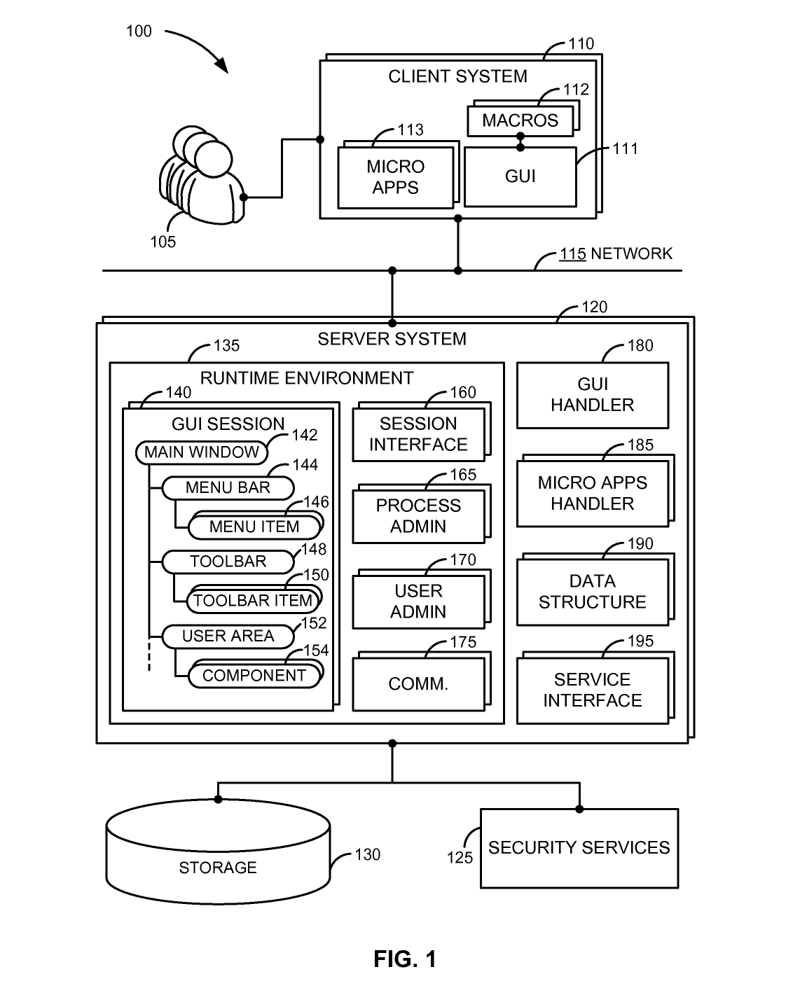

FIG. 1 shows system architecture 100 enabling operation automation based on GUI objects, according to one embodiment. A number of users 105 access the functionality of one or more software applications executed on server system 120 through one or more client computer systems 110 via network 115. The server system 120 establishes runtime environment 135 where the execution of the software applications take place. In one embodiment, the server system 120 executes as an application server platform. More than one physical or logical severs with same architecture and functionality may run in a cluster in the server systems 120.

To grant access to the functionality of a particular software application, GUI session 140 is created in the runtime environment 135, where objects 142 to 154 corresponding to predefined GUI objects are instantiated. GUI 111 is generated in one or more of the client systems 110. The GUI 111 contains GUI objects based on the objects 142 to 154 of the GUI session 140. Different sets of GUI objects may be included in the GUI 111 generated in different client systems 110 depending on factors like the system hardware, user rights, location, execution context, etc. Users 105 request application operations by interacting with the GUI objects in the instantiated GUI 111. These interactions are propagated to the corresponding objects 142-154 in the GUI session 140 through GUI handler 180. The data or the state of the underlying business objects are altered when the session 140 is updated through GUI 111.

The GUI 111 generated on client systems 110 could provide means for automating user actions by using external client applications or scripts, e.g. macros 112. The macros 112 may access the GUI objects in GUI 111 through established interfaces based on different programming technologies, e.g., COM+™ component services, Java™ beans, etc. The GUI objects are generated in the instantiated GUI 111 to execute the macros 112. In many cases, a client side software application is running to host the GUI 111 and to provide interface for plugging the macros 112 enhancements. The macros 112 may be executed by users different from the user who has instantiated the GUI 111, which may cause security issues.

In one embodiment, the functionality of a software application is enhanced by creating and executing applications, e.g. micro apps 113, at the client systems 110. The micro apps 113 do not require GUI 111 to be instantiated in the client systems 110. The micro apps 113 send operation requests directly to the objects in the GUI session 140. The micro apps may be written in compliance with different technologies, and executed in parallel on one or more of the client systems 110. For example, micro apps 113 may be Representational State Transfer (REST, RESTful indicate compliance with REST) technology based for generating server requests, Structured Query Language (SQL) based for relational database requests, Really Simple Syndication (RSS) compliant for publishing, etc.

In one embodiment, the GUI session 140 exposes objects 142 to 154 through one or more session interfaces 160 corresponding to the different technologies used for building micro apps 113, e.g., REST, SQL, etc. The operation requests generated by the micro apps 113 may be routed to the pertinent objects 142 to 154 directly or through micro apps handlers 185, depending on the implementation. Different micro apps handlers 185 may be generated according to the different technologies used for creating the micro apps 113. Similar to the GUI handler 180, the micro apps handlers 185 establish communication channels between the client systems 110 and the server system 120 for exchanging operation requests and results. In some embodiments, one or more data structures 190 may be generated to store information pertinent to the exposed objects 142 to 154 of the GUI session 140. This information may be extracted from the GUI session 140 or from other internal or external sources. The data structures 190 may be used to buffer the execution of the operation requests generated by micro apps 113.

Generally, the server system 120 generates a number of service interfaces 195 for different purposes. For example, security services 125 may be provided through one of the service interfaces 195. Another service interface 195 may ensure connectivity to storage 130. Yet another service interface 195 may maintain data exchange with other application servers, e.g., legacy systems. The security services 125 may impose a set of security related rules. For example, the security rules may generate particular authorization requirements for granting access to the GUI session objects. The GUI handler 180 and the micro apps handlers 185 may impose those requirements when establishing communication channels with the client systems 110. The storage 130 may persist the application and domain model data and metadata, as well as the current state of the GUI session 140, according to one embodiment.

According to one embodiment, the main task of the runtime environment 135 is to execute the software applications deployed in the server system 120. Several process threads may run simultaneously in the runtime environment 135. Every process thread may execute different instances of one or more software applications. Respectively, more than one GUI session 140 may be created at the same time for the running applications. The server system 120 may generate a multi-user runtime environment 135, where each user may run several independent software applications or application instances. Process admin 165 and user admin 170 modules of the runtime environment 135 may ensure the necessary low level operating system support for multi-user multi-thread processing. Further, the process admin 165 and user admin 170 modules may provide means for monitoring and controlling the parameters of the runtime environment 135. Communication module 175 connects the runtime environment 135 to database systems, external application systems, e.g., messaging systems, etc.

The server system 120 transmits the information necessary to generate the GUI 111, including the GUI objects. Therefore, there is a close correspondence between the objects 142 to 154 and the GUI objects, e.g. screens and screen elements, generated in GUI 111 at the client systems 110. A user who is familiar with the GUI screens and necessary actions to perform a particular task manually, would be able to directly implement this knowledge in the development of both macros 112 and micro apps 113. In one embodiment, micro apps 113 are developed as client programs directly interacting with objects 142 to 154 of GUI session 140. Therefore, it is not necessary to instantiate GUI 111 to execute micro apps 113. Further, the users executing the micro apps 113 may be directly authorized against the GUI session 140, resolving the security issues associated with macros 112.

The exemplary system architecture 100 illustrated in FIG. 1 is generally based on the architecture of NetWeaver™ application server provided by SAP® AG. Other embodiments of the invention may be implemented in computer systems with different architectures, including different modules or different module functionality.

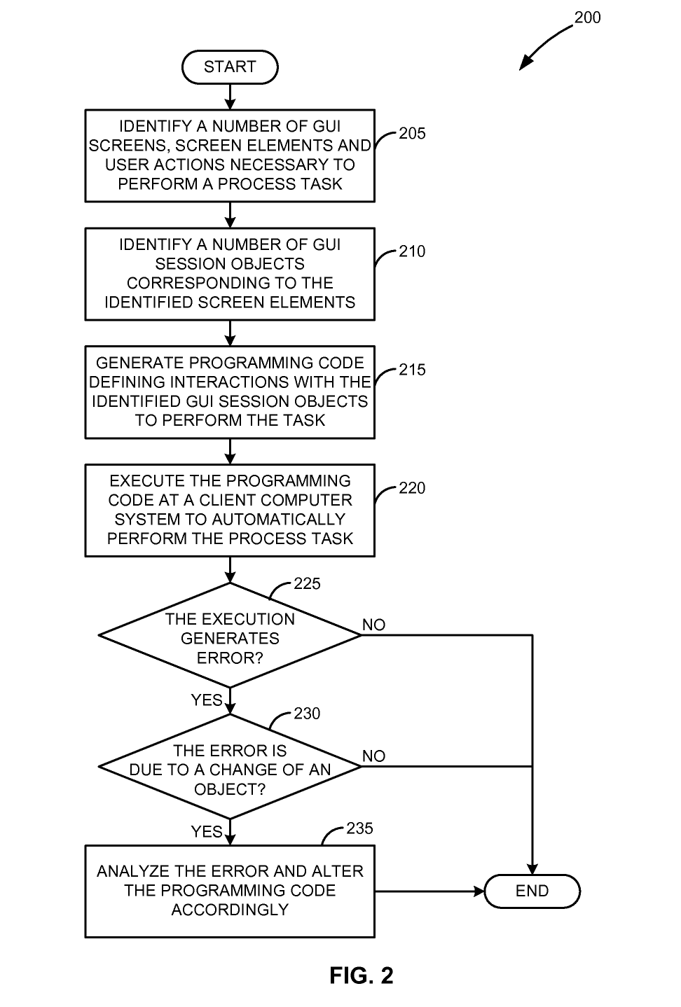

FIG. 2 illustrates process 200 for developing and executing client side programs to enhance the functionality of a software application based on the application GUI. At 205, a number of GUI screens, screen elements and pertinent user actions to perform a process task are identified. Different approaches for identifying the screens, screen elements and actions may be applied. For example, an experienced user may describe his or her work procedures for performing the task. Alternatively, the user activities, together with the involved screens and screen elements may be recorded either manually, by the user or by an observer, e.g., a programmer, or automatically.

Once the screens and screen elements involved in performing the task in the software application are recognized, a number of GUI session objects corresponding to the screen elements are identified at 210. In one embodiment, the screen descriptions are transmitted from the GUI session created in a server computer system to a GUI generated on a client computer system. Hence, all information required to generate the screen content already exists server side. The GUI session objects are available in the runtime environment of the server system, hierarchically organized and coherent with the business objects underlying the software application. The internal GUI object model of the application corresponds to both the GUI session objects instantiated in the server system, and the GUI objects instantiated in the client systems. Therefore, the identification of the corresponding GUI session objects is usually a straightforward process, not requiring specific knowledge about the domain model of the software application.

At 215, programming code is generated to define interactions between the identified GUI session objects. Generally, the interactions that are programmed resemble the user actions performed in the GUI environment on the client systems to accomplish the task. In one embodiment, some of the actions users perform may be omitted, e.g. moving a pointer between different screen elements, scrolling, mouse clicks to select one or more GUI objects, etc. Other optimizations of the programming code are also possible. For example, mimicking the user navigation between windows may not be necessary as the GUI session may keep instances of objects corresponding to GUI objects from different GUI screens or windows. Sometimes, however, such optimizations may not be possible, e.g., when a GUI object, and respectively, its corresponding GUI session object are created as a result of the user navigation.

The programming code may be written on virtually any programming or scripting language. However, it is important to provide client instructions and to exchange data with the server system compliant with supported communication protocols. For example, if the server computer system maintains communication channels based on REST and SQL technologies, the programming code needs to generate either RESTful or SQL compliant service requests.

At 220, the programming code is executed at a client computer system to automatically perform the process task. There may be different approaches to make the programming code available for execution. For example, the programming code may be executed as a standalone application. In one embodiment, the programming code may be invoked from another client-side application, e.g., as a plug-in extension. Thus, popular client side software products, like MS Office™, Lotus Notes™, various Internet browsers, etc., can be integrated with the software application running on the server system in a lightweight manner, without generating a client side GUI.

At 225, whether the execution of the automated user activities generates error or not is verified. If an error is generated, at 230 it is checked whether the error is due to a change of an object. For example, the GUI objects may be altered between the application versions, e.g., an existing screen element may be removed or changed. Generally, changes in the GUI objects are related with changes in the corresponding GUI session objects. At 235, the error is analyzed and the programming code is altered to reflect the change in the GUI session object or objects.

In one embodiment, the programming code is built to automatically adjust to some changes in the GUI. For example, the programming code may still function properly when the type of data that could be stored in a particular GUI object changes. Similarly, the programming code may be executed correctly when, for example, new GUI objects are included, removed or altered. In one embodiment, the programming code may adjust to changes in the structure of one or more business objects underlying the software application.

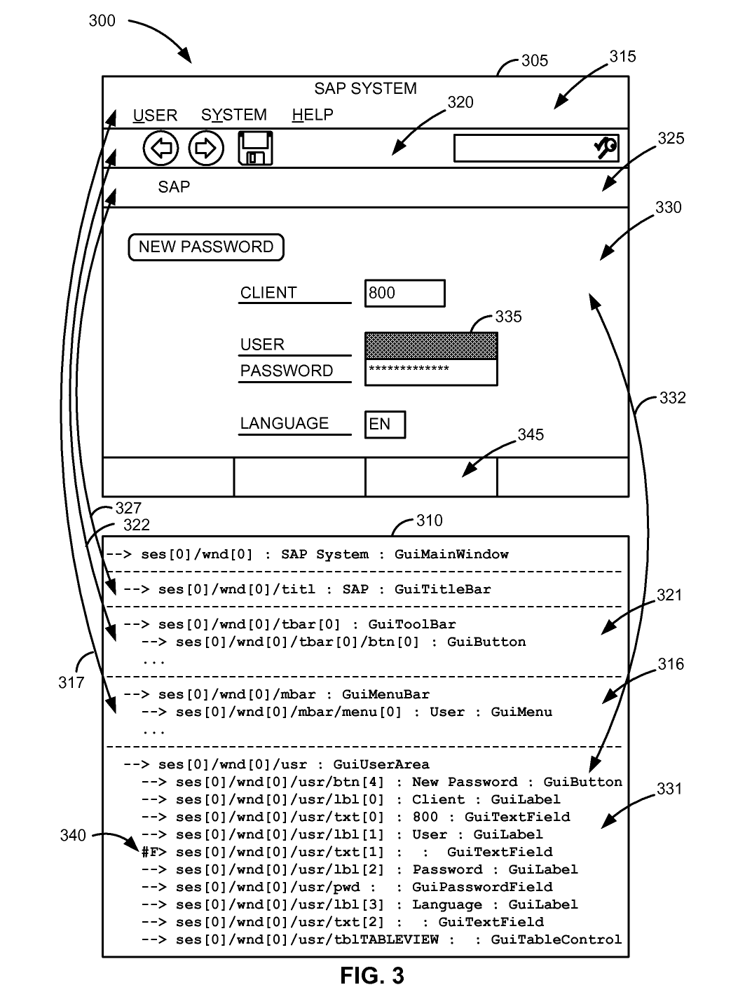

FIG. 3 shows correspondence 300 between an exemplary GUI screen 305 and exemplary snippets of programming code 310. In one embodiment, the programming code 310 may be translated to RESTful operation requests. The screen 305 is the GUI object “GuiMainWindow”. As denoted in the first snipped of the programming code 310, the “GuiMainWindow” object corresponds to a first window object “wnd[0]” of a first session “ses[0]” in the server system runtime environment. The value of the “GuiMainWindow” GUI object, and respectively the value of the “wnd[0]” object of the GUI session “ses[0]”, is set to “SAP System”.

The main screen 305 is divided in four main areas—a menu area 315 representing GUI object “GuiMenuBar”, a toolbar area 320 representing GUI object “GuiToolBar”, a title bar 325 area representing GUI object “GuiTitleBar”, and a user area 330 representing GUI object “GuiUserArea”. Arrows 317, 322, 327 and 332 relate the screen 305 areas 315, 320, 325 and 330 with the corresponding programming areas 316, 321, 326 and 331 of code snippets 310. The GUI objects “GuiMenuBar”, “GuiToolBar” and “GuiUserArea” have child GUI objects. For example, “GuiToolBar” includes a number of buttons. The GUI object “GuiTitleBar” does not have child objects. The GUI session object “titl” corresponding to the GUI object “GuiTitleBar” has value set to “SAP”.

The GUI object “GuiUserArea” and respectively the GUI session object “usr” have a number of child objects as illustrated in FIG. 3. Including one “GuiButton” object, one “GuiPasswordField” object, and several “GuiLabel” and “GuiTextField” objects. Text field 335 of user area 330 is illustrated as dimmed to mark that is currently selected, e.g., the GUI focus is set to the text field element 335. The respective row 340 in the programming code snippets 310 shows that the focus of the GUI session is set to the corresponding “txt[1]” object.

The user area 330 includes a table control element 345. Respectively, GUI object “GuiUserArea” also includes one “GuiTableControl” GUI object 345. The GUI object 345 may represent information in a table-like form extracted from the “tblTABLEVIEW” GUI session object, as illustrated with the last line of the programming code snippets 310.

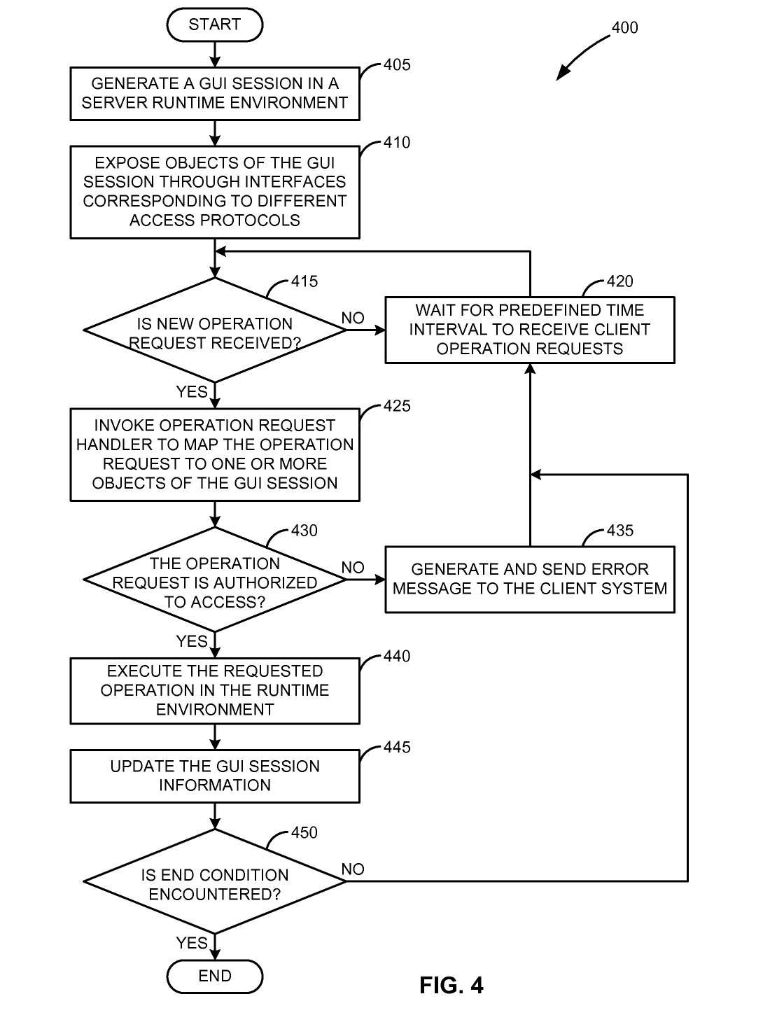

Programming codes for automating user actions and expanding software application functionality may be executed in one or more client computer systems. Accordingly, the client computer systems are sending operation requests to one or more active GUI sessions created in a server system where the software application is executed. FIG. 4 shows process 400 for executing such client operation requests at a server computer system, according to one embodiment.

At 405, at least one GUI session is generated in a runtime environment established at a server system. For the purpose of this document, it can be assumed that one GUI session is created when the execution of an instance of a respective software application has been launched. A number of GUIs connected to the created GUI session may be instantiated on a number of client computer systems. The client GUIs communicate with the GUI session through a GUI channel. Generally, the client GUIs are instantiated in response to user connection request. Authentication data is initially sent to the application server through the GUI channel. Respectively, the content of an instantiated client GUI depends on the system or application rights assigned to the requesting user.

At 410, objects of the GUI session are exposed through a number of interfaces corresponding to different access protocols. The access protocols specify the format in which operation requests and data are exchanged between the GUI session and client systems executing programming code for automating application tasks.

The client systems communicate with a GUI session through one or more communication channels compliant with the technologies or protocols of the generated operation requests. The access to the GUI session is authorized according to the rights or privileges of the users invoking the programming code for automating application tasks at the client systems. Respectively, the connection of the programming code, e.g. micro apps, to the GUI session may depend on authentication data exchanged between the client and server systems via a corresponding micro apps channel.

At 415, a check is performed whether a new operation request is received from a client system. The check may be performed recurrently at predefined time intervals as specified at 420. When the check confirms that a new operation request is received, the process 400 continues at 425 with invoking operation request handler to map the operation request to one or more objects of the GUI session. Alternatively, the operation request handler may be directly triggered by a new client operation request, without performing the check of 415. In one embodiment, the operation request handler is a communication channel compliant with the protocol of the received operation request.

The operation request handler may authenticate the user associated with the operation request before or after mapping the operation request to one or more objects of the GUI session. Thus, at 430, it is verified if the operation request is authorized to access the objects of the GUI session it references. If such authorization is not granted, e.g., due to insufficient user rights or due to other security reasons, the execution of the current operation request is interrupted and, at 435, an error message is generated and sent to the client system. The process 400 continues at 420, waiting for the predefined time interval to receive another client operation request.

At 440, the current operation request is executed in the runtime environment, when the operation request is authorized to access the corresponding GUI session objects. The execution of the request may change the properties or the values associated with the GUI session objects mapped to the operation request. Therefore, at 445, the information associated with the GUI session is updated. Such an update usually causes changes in the business objects underlying the software application, as well. Process 400 ends when at 450 it is verified that an end condition is encountered, e.g., the execution of the software application instance is interrupted.

In one embodiment, a REST operation call is made by a client micro app against a handler or a communication channel of the server system. The handler forwards the request to the corresponding GUI session. When the request is properly authorized, the handler may be able to read the definitions of the relevant objects of the GUI session. Thus, the handler would act as a generic interface to the GUI session to process hypertext transfer protocol (HTTP) operation request calls.

For example, the following HTTP operation request is received at a server system:

https://<SAP SYSTEM URL>/<URL OF HANDLER>/
sessions/<SESSIONKEY>/controls/wnd[0]/usr/txt[0]
?method=post&value=BASIC

The exemplary request is routed to a REST compliant micro app handler, e.g., GUI session channel. The micro app handler verifies that “SESSIONKEY” identification corresponds to the created GUI session. Further, the handler checks if the GUI session object “txt[0]” exists as a component in the corresponding “wnd[0]” parent object for the user initiating the operation request at the client system. If “txt[0]” exists, e.g., the user has sufficient rights, the handler passes “value” parameter to the “txt[0]” object. The runtime environment processes the change, and updates the GUI session information, e.g., propagate the change to a corresponding element of an underlying business object.

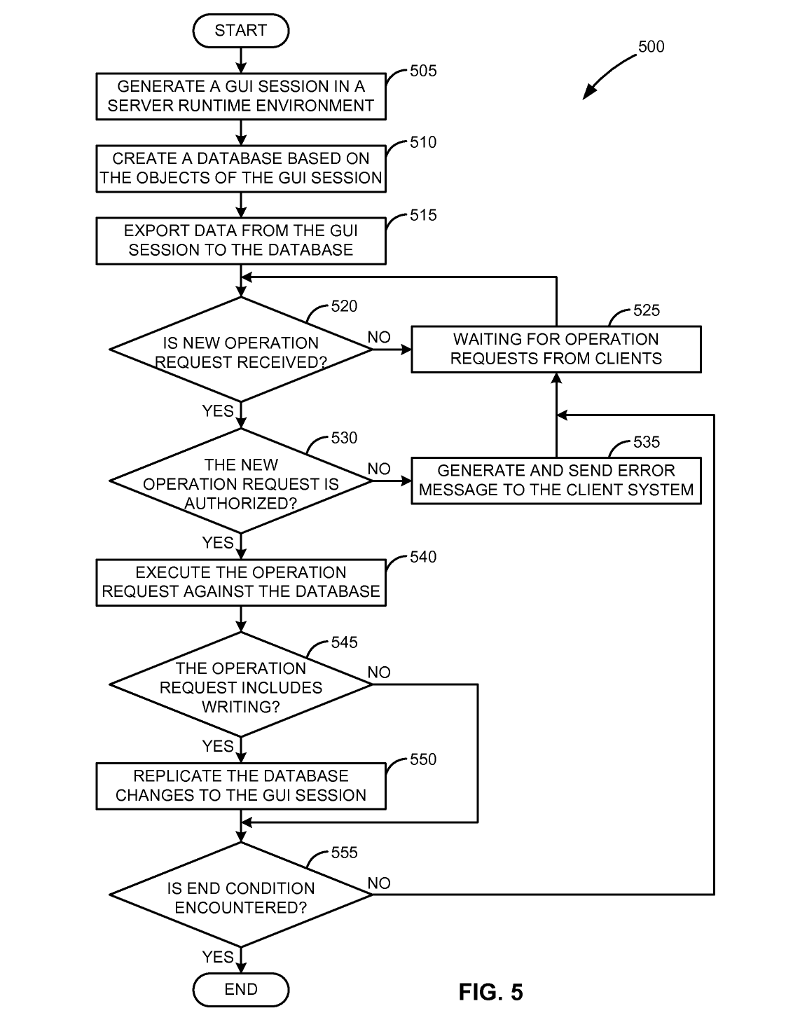

FIG. 5 shows process 500 for executing client operation requests at a server computer system in a slightly different way compared to process 400 of FIG. 4, according to one embodiment. At 505, a GUI session is generated in a server runtime environment. At 510, a database or another kind of data structure is created at the server system. The database or the data structure is based on the objects of the GUI session. For example, an object of the GUI session may include a table-like element to present data in a corresponding screen GUI object. The data structure created at 510 may include a table corresponding to the table-like element. At 515, data from the GUI session is exported to the generated database, according to the correspondence between the objects of the GUI session and the database entities.

At 520, a check is performed whether a new operation request is received. Process 500 waits for a certain time period at 525 if no new operation request is received, before checking again at 520. When there is a new operation request, it is verified at 530 whether this operation request is authorized, e.g., whether the requesting user has the necessary rights to interact with the GUI session objects referred in the request. At 540, the operation request is executed against the generated data structure, if authorized. Otherwise, error message is generated and sent to the client system at 535.

Process 500 continues at 545 by verifying whether the operation request includes writing actions. The writing actions cause changes to the data stored in the created data structure. When such actions are included in the operation request, the changes made in the data structure have to be replicated to the GUI session and the corresponding objects at 550. The process 500 ends when an end condition is encountered at 555.

In one embodiment, a data snapshot may be dynamically generated based on the exposed GUI session objects. The data snapshot may include a subset of the data currently included in the GUI session objects. The structure of the data snapshot may correspond to the structure of one or more objects of the GUI session. The GUI session objects may be exposed trough a runtime interface compliant with the format of an operation request. The data snapshot may be generated by a corresponding micro apps handler before or when the operation request is received. The data snapshot may be stored in the dynamic memory of the server system, according to one embodiment.

For example, a programming code executed on a client system may generate SQL based operation requests. An interface running in the same runtime process thread where the GUI session is instantiated may expose the objects of the GUI session as a relational database structure. A simple read operation request may have syntax similar to:

SELECT * FROM <SESSIONKEY>/wnd[0]/usr/tblTABLEVIEW
WHERE project = ”Imagineering Projects”;

In this example, a micro apps handler compliant with SQL based operation requests exports data contained in the current GUI session into tables within an in- memory database corresponding to the GUI session, e.g., named after the session identifier (“SESSIONKEY”). The SQL based operation request is passed to the handler to verify the “SESSIONKEY”, and any supplemental authorization information. If the authorization is successful, the handler executes the query included in the request against the in-memory database. The result is passed back to the requesting client system. In one embodiment, write operation requests cause the updated in-memory data to be written back into the corresponding GUI session objects to ensure consistency. Any error messages during the operation request execution may be returned as SQL error messages.

In one embodiment, multiple computer programmable interfaces are dynamically generated in a server system runtime environment. The interfaces may represent separate views of a single GUI session state of a software application instance held in the runtime environment at a given moment. The GUI session state represents a screen content that would be accessible through a GUI of the software application generated at a client system. The interfaces allow for easy learning, lightweight application development, based on modern interaction technologies, e.g., REST for transaction execution, SQL for table-like organized data extraction, RSS for representation of inbox items, etc. The multiple interfaces may run in parallel allowing simultaneous execution of operation requests against the GUI session in the server runtime environment.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

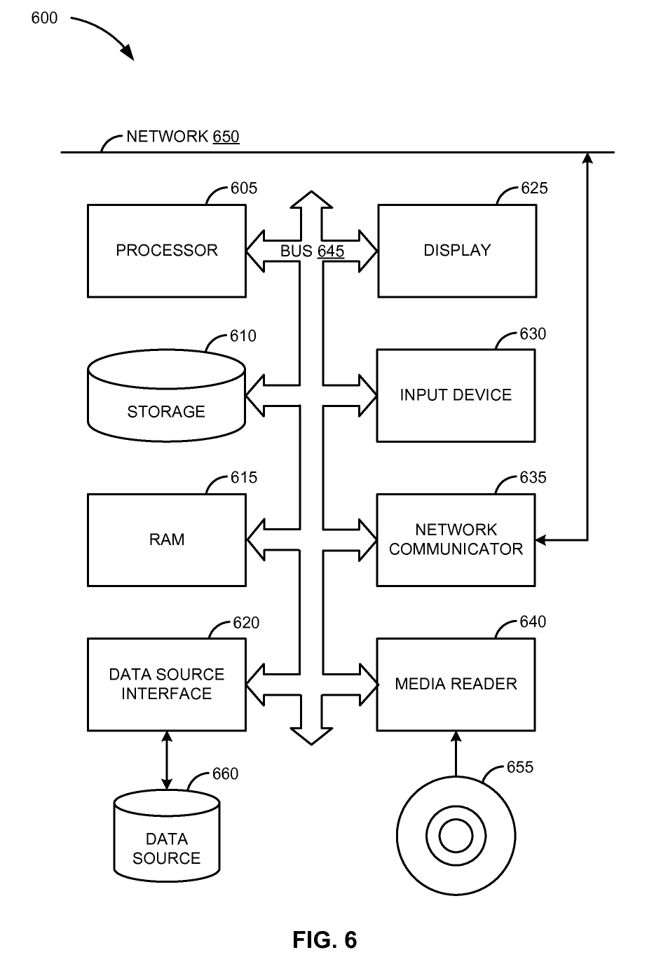

FIG. 6 is a block diagram of an exemplary computer system 600. The computer system 600 includes a processor 605 that executes software instructions or code stored on a computer readable storage medium 655 to perform the above-illustrated methods of the invention. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment of the invention, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed via network 650. In some embodiments the data source 660 may be accessed by an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a non-transitory computer readable storage medium to tangibly store instructions, which when executed by a computer, cause the computer to:
generate a graphical user interface (GUI) session in a runtime environment based on a software application executing in the runtime environment, wherein the GUI session includes a plurality of objects;
create a plurality of GUI channels to handle client operation requests, wherein a first GUI channel of the plurality of GUI channels complies with a first access protocol type, and a second GUI channel of the plurality of GUI channels complies with a second access protocol type;
receive a first client operation request directed to at least one object of the GUI session, wherein the first client operation request is compliant with the first access protocol type; and
execute the first client operation request against the at least one object via the first GUI channel.

2. The article of manufacture of claim 1, wherein the non-transitory computer readable storage medium tangibly stores further instructions, which when executed by the computer cause the computer to:
receive a second client operation request directed to at least one object of the GUI session, wherein the second client operation request is compliant with the second access protocol type; and
execute the second client operation request against the at least one object via the second GUI channel.

3. The article of manufacture of claim 1, wherein creating the plurality of GUI channels comprises:
exposing the plurality of objects of the GUI session to the first GUI channel through a first interface; and
exposing the plurality of objects of the GUI session to the second GUI channel through a second interface simultaneously with the first interface.

4. The article of manufacture of claim 3, wherein the non-transitory computer readable storage medium tangibly stores further instructions, which when executed by the computer cause the computer to:
generate a second GUI session in the runtime environment based on the software application executing in the runtime environment, the second GUI session including a plurality of objects; and
expose the plurality of objects of the second session to the first GUI channel through the first interface.

5. The article of manufacture of claim 1, wherein receiving the first client operation request comprises:
via the first GUI channel, authenticating user rights associated with the first client operation request to grant access to the at least one object.

6. The article of manufacture of claim 1, wherein executing the at least one action comprises:
generating a data structure by the first GUI channel based on the plurality of objects of the GUI session exposed through the first interface;
storing a current state of the plurality of objects of the GUI session into the data structure; and
executing an action against the data structure in response to the first client operation request.

7. The article of manufacture of claim 6, wherein the non-transitory computer readable storage medium tangibly stores further instructions, which when executed by the computer cause the computer to:
transfer data from the data structure to the at least one object of the GUI session in response to a write action of the first client operation request.

8. The article of manufacture of claim 1, wherein executing the at least one action comprises:
updating at least one business object underlying the software application.

9. A computerized method for executing GUI based operation requests comprising:
generating a GUI session in a server computer system runtime environment, wherein the GUI session includes a plurality of objects;
exposing the plurality of objects of the GUI session through a plurality of interfaces, wherein a first interface of the plurality of interfaces complies with a first access protocol type and a second interface of the plurality of interfaces complies with a second access protocol type;
receiving via a computer network a first client operation request directed to at least one object of the GUI session, wherein the first client operation request is compliant with the first access protocol type; and
executing at least one action based on the first client operation request against the at least one object through the first interface.

10. The method of claim 9 further comprising:
receiving via the computer network a second client operation request directed to at least one object of the GUI session, wherein the second client operation request is compliant with the second access protocol type; and
executing at least one action based on the second client operation request against the at least one object through the second interface.

11. The method of claim 9 further comprising:
updating GUI session data based on the executed at least one action; and
persisting the GUI session data in a storage.

12. The method of claim 9, wherein exposing the plurality of objects comprises:
generating a data structure based on the plurality of objects of the GUI session by an interface of the plurality of interfaces.

13. The method of claim 9, wherein receiving the first client operation request comprises:
authenticating user rights associated with the first client operation request to grant access to the at least one object.

14. The method of claim 9, wherein executing the at least one action comprises:
updating at least one business object underlying a software application executing on the server computer system.

15. The method of claim 9, wherein executing the at least one action comprises:
exporting data from the at least one object of the GUI session into a database table; and
executing a query against the database table in response to the first client operation request.

16. The method of claim 15 further comprises:
transferring data from the database table to the at least one object of the GUI session in response to a write action of the first client operation request.

17. A computer system for process automation based GUI comprising:
a memory to store computer instructions; and
a processor coupled to the memory to execute the computer instructions to:
generate a GUI session in a runtime environment, wherein the GUI session includes a plurality of objects,
instantiate a plurality of interfaces in the runtime environment to expose the objects of the GUI session, to a plurality of GUI channels,
wherein a first GUI channel of the plurality of GUI channels is compliant with a first protocol type, and a second GUI channel of the plurality of GUI channels is compliant with a second protocol type,
receive a first client operation request directed to at least one object of the GUI session, wherein the first client operation request is compliant with the first protocol type, and
executing the first client operation request against the at least one object of the GUI session via the first GUI channel and through a corresponding interface of the plurality of interfaces.

18. The system of claim 17, wherein the memory store further instructions to be executed by the processor to:
receive a second client operation request directed to at least one object of the GUI session, wherein the second client operation request is compliant with the second protocol type; and
execute the second client operation request against the at least one object of the GUI session via the second GUI channel and through a corresponding interface of the plurality of interfaces.

19. The system of claim 17, wherein executing the first client operation request comprises:
generating a data structure by the first GUI channel based on the plurality of objects of the GUI session exposed through a corresponding interface of the plurality of interfaces; and
storing a current state of the plurality of objects of the GUI session into the data structure.

20. The system of claim 17, wherein executing the first client operation comprises:
updating at least one business object underlying a software application executing in the runtime environment.
